(19) United States
(12) Patent Application Publication
(10) Pub. No.: US 2021/0291639 A1
(43) Pub. Date: Sep. 23, 2021

(54) AIR GUIDE FOR A MOTOR VEHICLE, MADE OF A PIECE OF EXPANDED POLYMER MATERIAL, AND COMPRISING IMPACT ABSORBING ZONES

(71) Applicant: RENAULT s.a.s., Boulogne-Billancourt (FR)

(72) Inventors: Frederic PEAN, Saint Cyr l'Ecole (FR); Nicolas DUBOIS, Ollainville (FR); Sebastien DIDIER, Beynes (FR)

(73) Assignee: RENAULT s.a.s., Boulogne-Billancourt (FR)

(21) Appl. No.: 17/258,982

(22) PCT Filed: Jun. 27, 2019
(86) PCT No.: PCT/EP2019/067192

§ 371 Date: Jan. 8, 2021

(30) Foreign Application Priority Data
Jul. 10, 2018 (FR) 1856301

(51) Int. Cl. B60K 11/08; B62D 25/08; B62D 29/04

(52) U.S. Cl. CPC B60K 11/08; B62D 29/043; B62D 25/084

(57) ABSTRACT

A one-piece air guide, which is made of expanded polymer material, is intended to be integrated into the front of a vehicle between a technical front end connected to a crossmember by longitudinally compressible elements and a front wall of the vehicle provided with at least one ventilation opening. The air guide has a front surface, a rear surface, and a plurality of longitudinal walls connecting the front surface to the rear surface and extending parallel or substantially parallel to the longitudinal direction of the vehicle when the air guide is mounted inside the vehicle. At least part of the longitudinal walls has a restriction area of smaller thickness than the thickness of the wall on either side of the restriction area.

The invention relates to a one-piece air guide intended to be incorporated in the front of a vehicle, notably fixed to a technical front end of the vehicle. The air guide according to the invention is made of a piece of expanded polymer material, notably expanded polypropylene, and comprises impact-absorbing zones.

The function of such an air guide is to channel the air entering through at least one ventilation opening or grille in the front wall or front bumper skin of the vehicle to direct it to a set of elements grouped together in what is called a “cooling set”. This term is used to designate the set of elements necessary for the cooling of the engine, sometimes stacked in layers or partly superposed. The cooling set is conventionally composed of the engine cooling water radiator, and possibly the air-air exchanger for cooling the turbocharger and the condenser.

In the industry, “technical front end” (FAT) designates a structure which is located in front of the engine block and whose function is to support various members, primarily the radiator of the engine block. The FAT can take many forms. In some cases, it is reduced to a simple transverse beam. In other cases, it constitutes a chassis of more or less complex form incorporating the cooling set. The FAT also incorporates various functions such as support for hood bumpers, support for the hood latch or for a jamb supporting the hood latch, etc.

Compliance with increasingly stringent CO₂ emissions standards is leading motor vehicle constructors to lighten vehicles, all the more intensively as the number of driving assistance devices embedded in vehicles is tending to increase (proximity sensors, camera, active braking radar, dead angle detection). The applicant has proposed, in the document FR 3013302, a one-piece air guide made of polymer material. Such an air guide offers the advantage of being lightweight and simple to produce. An impact absorber situated in front of the crossmember is also provided, this absorber being able to be an independent block or be formed by a solid wall of the one-piece air guide which extends over the entire width of the vehicle. In all the cases, the impact absorber is relatively voluminous and bulky. Furthermore, this element exercises its impact absorption function only along the crossmember.

The invention aims to overcome these drawbacks by proposing a one-piece air guide made of expanded polymer material which has impact absorption zones while still not being bulky or voluminous.

To this end, the subject matter of the invention relates to a one-piece air guide made of expanded polymer material intended to be incorporated in the front of a vehicle between a technical front end linked to a crossmember by longitudinally compressible elements and a front wall of said vehicle provided with at least one ventilation opening, the air guide having a front face, a rear face and a plurality of longitudinal walls linking the front face to the rear face and extending parallel or substantially parallel to the longitudinal direction of the vehicle when the air guide is mounted inside the vehicle, characterized in that at least a part of the longitudinal walls has a restriction zone of smaller thickness than the thickness of the wall on either side of the restriction zone.

This restriction zone forms a zone of weakness which will allow the wall either to break or to fold in the event of an impact. Such breaking or folding makes it possible to absorb the impact undergone and to reduce the effects of this impact on the elements of the vehicle situated behind the air guide on the vehicle.

It should be noted that the thickness of the restriction zone can correspond to a minimum thickness of material to be observed for the production and/or the withstand strength of the part.

The polymer material used to produce the air guide according to the invention is chosen from among expanded polymer materials, for example expanded polypropylene or expanded polystyrene, preferably expanded polypropylene. “Expanded polymer material” is understood to mean a cellular material formed from a solid polymer phase and a dispersed gaseous phase. This type of cellular material is also sometimes called “foam”. They are notably rigid materials, namely materials which do not become deformed under the effect of their own weight. Such expanded materials offer the advantage of being lightweight, which makes it possible to produce lightweight air guides, for example with weights of the order of 1 kg or less.

Advantageously, it is possible to use an expanded polypropylene with a density of 30 to 90 g/L, preferably of 30 to 45 g/L.

In particular, this air guide can be a top air guide, namely disposed above a crossmember of the motor vehicle in the position of mounting of the air guide.

Some longitudinal walls can be linked to one or more erect walls, perpendicular or substantially perpendicular to the longitudinal direction of the vehicle. The presence of these erect walls increases the rigidity of the longitudinal wall, to the detriment of impact absorption. In this case, advantageously, the zones of thickness restriction can be situated on longitudinal walls linked to one or more erect walls allowing an impact absorption on the most rigid longitudinal walls.

Generally, for good efficiency, it is advantageous to dispose a restriction zone perpendicularly or substantially perpendicularly to the direction of the force/impact that the zone must absorb. This direction of the force/impact is more often than not parallel or substantially parallel to the longitudinal direction of the vehicle, the air guide being mounted inside the vehicle. Thus, advantageously, the restriction zone or zones extends or extend perpendicularly or substantially perpendicularly to the longitudinal direction when the air guide is mounted inside the vehicle.

Advantageously, each restriction zone can define a groove with flared U-shaped cross-section. This can simplify the production of the restriction zone, notably by injection molding. Notably, the flared edges of the U-shaped section can form, between them, an angle of 5 to 60°, an angle of 50° being typically applied in the exemplary embodiment illustrated.

The invention relates also to a motor vehicle comprising a technical front end linked to a crossmember by longitudinally compressible elements and a front wall provided with at least one ventilation opening, characterized in that it comprises at least one air guide according to the invention disposed between the crossmember and the technical front end.

In particular, the air guide can be a top air guide disposed also above the crossmember.

The invention is now described with reference to the nonlimiting attached drawings, in which:

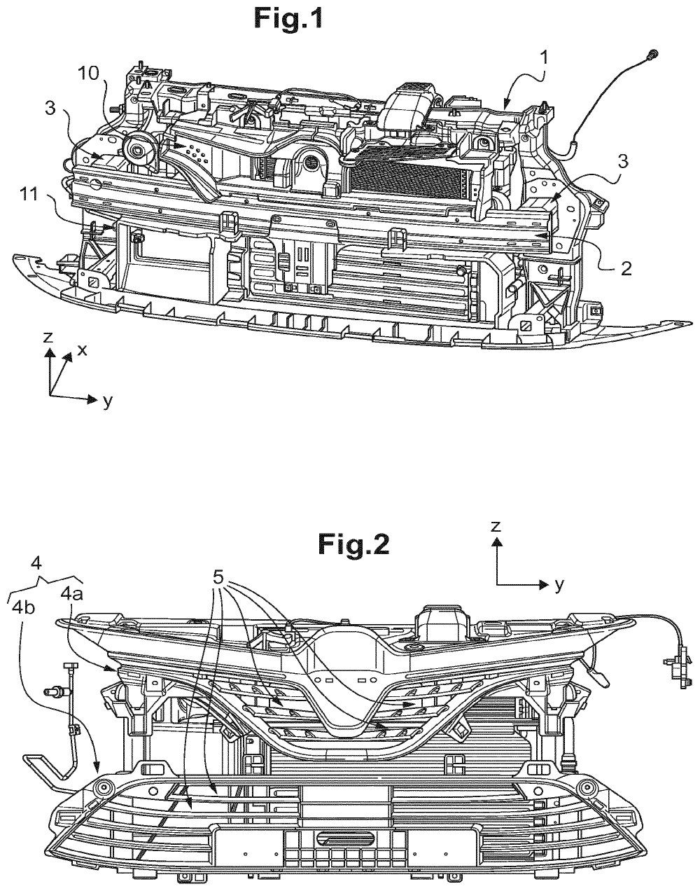

FIG. 1 is a perspective view of an air guide according to an embodiment of the invention, mounted on an FAT of a motor vehicle, between the FAT and the crossmember of the vehicle;

FIG. 2 is a front view of the front part of a vehicle comprising the elements of FIG. 1 and a bumper;

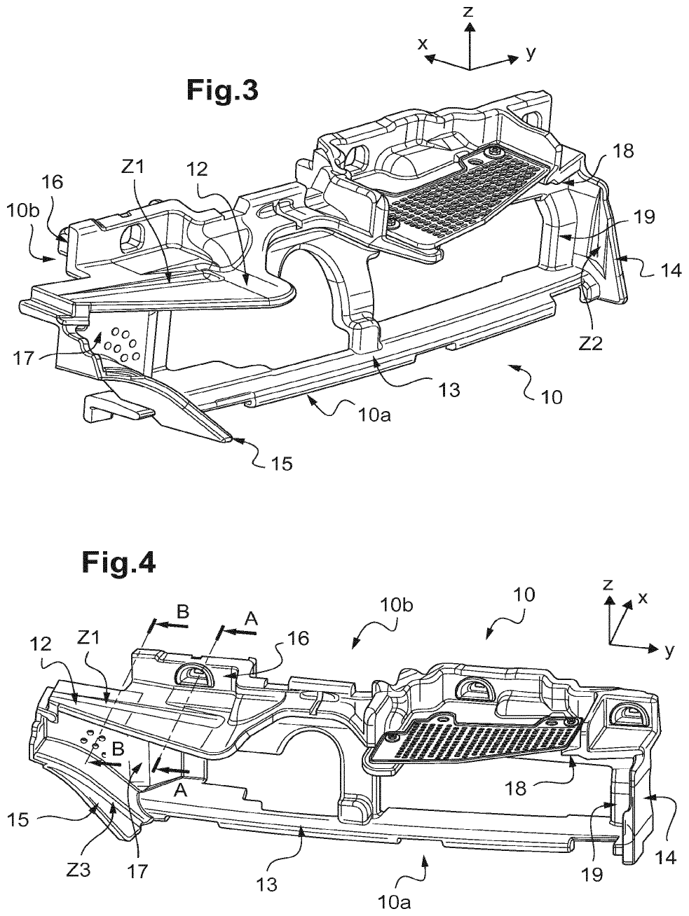

FIGS. 3 and 4 are perspective views of the top air guide represented in FIG. 1;

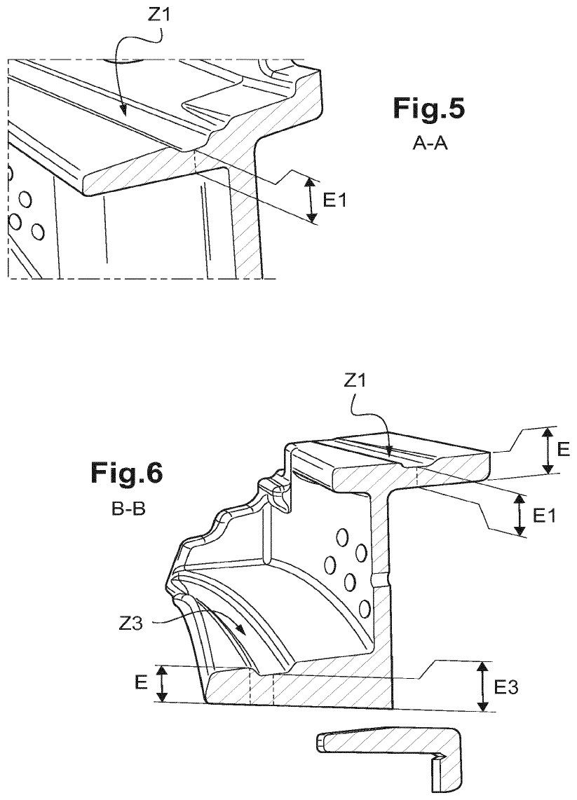

FIGS. 5 and 6 are partial cross-sectional views of the air guide along the lines A-A and B-B of FIG. 4.

In the present description, the terms front, rear, top, bottom, refer to the front and rear directions of the vehicle, to the top and bottom of the vehicle, when the air guide is mounted on the vehicle. The axes X, Y, Z correspond, respectively, to the longitudinal axis (from front to rear), the transverse axis and the vertical axis of the vehicle, the latter resting on the ground. The vertical direction thus corresponds to the direction of gravity.

Substantially horizontal, longitudinal or vertical is understood to mean a direction/a plane forming an angle of at most ±20°, even at most 10° with a horizontal, longitudinal or vertical direction/plane.

Substantially parallel, perpendicular or right-angled is understood to mean a direction/an angle deviating by at most ±20°, even at most 10° or at most 5° from a parallel, perpendicular or right-angled direction.

FIG. 1 represents, partially in perspective, the front part of a motor vehicle on which the FAT 1 of the vehicle, the extreme front crossmember 2 and longitudinally compressible elements 3 (crash box) secured to the ends of the crossmember 2 can be seen. These compressible elements 3 are fixed to the FAT 1, generally in the extension of the stringers (not represented). Between the FAT 1 and the crossmember 2, fixed to the FAT 1, there are disposed a top air guide 10 and a bottom air guide 11. The top air guide 10 is disposed above the crossmember 2, bearing thereon, while the bottom air guide 11 is disposed below the crossmember 2 and is fixed thereto.

The crossmember 2, also called extreme front crossmember, is a structural part that notably makes it possible to absorb the forces upon a front-end impact and to distribute these forces according to the nature of the impact. This crossmember serves also as support for fixing elements such as a horn, a bracket for the geometry of the front face.

The FAT 1 here incorporates a cooling set as defined above.

FIG. 2 represents the same elements hidden behind the front wall 4 which comprises openings 5 for the passage of the air. The front wall 4 is, here, in two parts, a top part 4a and a bottom part 4b. A one-piece wall 4 can however be envisaged.

Each of the air guides 10, 11 is produced by a part made of expanded polymer material, for example obtained by injection molding. In the example, the polymer material is an expanded polypropylene, with a density of 30 to 90 g/L, preferably of 30 to 45 g/L. As an example, the products ARPRO®/P-block™ marketed by the company JSP can be used, as can the products Neopolen® from the company BASF.

The air guide 10 represented in FIG. 1 and in FIGS. 3 to 6 has a front face 10a, a face that is visible from the front of the vehicle, and a rear face 10b, that is visible from the rear of the vehicle. The front face 10a comes to bear against the front wall 4 of the vehicle, while the rear face 10b comes to bear against the FAT 1. Furthermore, the air guide 10 comprises a plurality of longitudinal walls 12-15 linking the front face 10a to the rear face 10b and extending parallel or substantially parallel to the longitudinal direction X of the vehicle when the air guide 10 is mounted inside the vehicle. Thus, these longitudinal walls 12-15 bear against the front wall 4 of the vehicle which will transmit to them all the forces undergone by the front of the vehicle in the event of an impact.

Some of these longitudinal walls 12-15 are also linked to so-called erect walls 16-19, extending perpendicularly or substantially perpendicularly to the longitudinal direction X. Thus, the longitudinal wall 12 is linked to two erect walls 16 and 17, the longitudinal wall 15 is an erect wall 17, the longitudinal wall 14 is linked to two erect walls 18, 19. This arrangement contributes to the rigidity of the air guide but can prove problematic for the absorption of impacts, notably impacts at low speed (less than 15 km/h).

According to the invention, the longitudinal walls 12, 14, 15 are provided with a restriction zone, Z1, Z2, Z3 respectively, whose thickness (referenced E1, E3 in the figures for the zones Z1 and Z3 respectively) is smaller than the thickness of the wall 12, 14, 15 on either side of the restriction zone, as can be seen in FIGS. 5 and 6. In the example represented, the thickness E1 or E3 of the restriction zones Z1, Z3 respectively corresponds to a minimum thickness of the wall. This minimum thickness can depend on the air guide manufacturing method and/or on the density of the expanded polymer material. For example, for an expanded polypropylene with a density of 30 g/L to 60 g/L, this minimum thickness can be from 10 mm±1 mm to 12 mm±1 mm. For a density of 30 g/L, the minimum thickness is typically 12 mm. For a density of 45 g/L, the minimum thickness is typically 10 mm.

Generally, in the example represented, the restriction zones Z1-Z3 take the form of grooves with flared U-shaped cross-section. Such a form offers the advantage of being easy to implement.

As an example, with a density of 30 g/L, a suitable thickness lies between 12 and 16 mm (limits included) with a restriction zone with a thickness of between 8 and 12 mm (limits included) For example, for a density of 30 g/L, the nominal thickness is typically 15 mm with 12 mm restrictions. For a density of 45 g/L, the nominal thickness is typically 13 mm with 10 mm restrictions. It is possible to locally provide local zones with a restriction to approximately 8 mm, and that can then require a movement in the mold.

The presence of these restriction zones according to the invention makes it possible to release energy when the front of the vehicle undergoes impacts such as:
impacts at low speed (commonly called “small impact” or parking impact <5 km/h), limiting the break to outer parts of the vehicle (bumper),
impacts from 10 to 15 km/h, thus limiting the parts to be changed and the repair costs,
so-called pedestrian impacts, limiting the severity of the injuries.

The effects of the impacts can thus be reduced very simply.

The invention has been described with reference to a top air guide. It is nevertheless understood that a restriction zone as described can be produced on a bottom air guide, even on an air guide forming both a bottom air guide and a top air guide.

Nor is the invention limited by the number and the position of the restriction zones, which will depend on the number and the position of rigid points of the air guide and/or on the number and the position of the elements situated behind the air guide and that are sought to be protected from an impact.

The invention makes it possible to very simply produce a zone of weakness capable of absorbing an impact, notably a small impact, however harming the function of the air guide, namely the seal-tightness of its walls, and without notably increasing the complexity of the production thereof.

1-7. (canceled)

8. A one-piece air guide made of expanded polymer material and configured to be incorporated in the front of a vehicle between a technical front end linked to a crossmember by longitudinally compressible elements and a front wall of said vehicle provided with at least one ventilation opening, the air guide comprising:
a front face, a rear face, and a plurality of longitudinal walls linking the front face to the rear face and extending parallel or substantially parallel to the longitudinal direction of the vehicle when the air guide is mounted inside the vehicle,
wherein at least a part of the longitudinal walls has a restriction zone of smaller thickness than the thickness of the wall on either side of the restriction zone.

9. The air guide as claimed in claim 8, wherein the longitudinal walls provided with the restriction zone are also linked to at least one erect wall perpendicular or substantially perpendicular to the longitudinal direction of the vehicle.

10. The air guide as claimed in claim 8, wherein the restriction zone extends perpendicularly or substantially perpendicularly to the longitudinal direction when the air guide is mounted inside the vehicle.

11. The air guide as claimed in claim 8, wherein the restriction zone defines a groove with flared U-shaped cross section.

12. The air guide as claimed in claim 8, wherein the expanded polymer material is an expanded polypropylene.

13. A motor vehicle, comprising:
a technical front end linked to a crossmember by longitudinally compressible elements and a front wall provided with at least one ventilation opening; and
at least one air guide as claimed in claim 8 disposed between the crossmember and the technical front end.

14. The motor vehicle as claimed in claim 13, wherein the air guide is a top air guide disposed also above the crossmember.
